(19) United States
(12) Patent Application Publication
(10) Pub. No.: US 2008/0053968 A1
(43) Pub. Date: Mar. 6, 2008

(54) Device for controlling emission of a laser beam in a large laser cutter

(75) Inventors: Chung-Ting Chang, Hsi Chih City (TW); Wen-Lung Liang, Hsi Chih City (TW); Yu-Chiung Kang, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/512,394

(22) Filed: Aug. 30, 2006

(51) Int. Cl. B23K 26/00

(52) U.S. Cl. 219/121.6; 219/121.67

(57) ABSTRACT

A device for controlling the emission of a laser beam in a large laser-carving machine includes a portable controller formed with a switch, and a cable extending between the portable controller and a main unit of the large laser-carving machine. Furthermore, the cable electrically connects the switch with the main unit in such a way that the switch may turn on/off a laser tube provided in the main unit of the large laser-carving machine.

### FIELD OF THE INVENTION

The present invention relates to a device for controlling the emission of a laser beam in a large laser-carving machine which could be operated quickly and conveniently in adjusting the focus of the laser beam.

### BACKGROUND OF THE INVENTION

A laser-carving machine generally works on a principle of emitting a laser beam and focusing it on a surface of something to be cut and carved. The absorption of light energy brings about a high temperature which melts or burns part of the material on which the laser beam is focused on. It is in such a way that the material is cut and carved.

Any conventional laser-carving machine is necessary to be adjusted before cutting and carving to ensure that the laser beam therein is focused at a correct position. A laser-carving machine of normal dimensions can be adjusted directly by a user at the control panel of the machine, but the adjustment for a laser-carving machine of huge dimensions necessitates the user to walk repeatedly between a place where the adjustment can be made and the control panel of the machine for turning on a laser tube to examine the result of the adjustment.

Although the troublesome and time-consuming process can be simplified by assigning it to two operators, one for the adjustment and the other for turning on the laser tube. However, another problem arises that one additional operator must involve in the task.

Therefore, there is a need for a device to overcome the problems mentioned above.

### SUMMARY OF THE INVENTION

It is an objective of the present invention to provide a device for controlling the emission of a laser beam in a large laser-carving machine quickly and conveniently during adjusting the focus of the laser beam.

To achieve the aforementioned objective, the present invention provides a device including a portable controller formed with a switch, and a cable extending between the portable controller and a main unit of the large laser-carving machine. Furthermore, the cable electrically connects the switch with the main unit in such a way that the switch may turn on/off a laser tube provided in the main unit of the large laser-carving machine.

Other objectives, advantages and novel features of this invention will become more apparent from the following detailed description when taken in conjunction with the accompanying drawings.

### BRIEF DESCRIPTION OF THE DRAWINGS

FIG. 1 is an exploded perspective view of a preferred embodiment of a device in accordance with the present invention for controlling the emission of a laser beam in a large laser-carving machine;

FIG. 2 is a perspective view of the inventive device of FIG. 1 in assembly;

FIG. 3 is a perspective view showing the device of the present invention held by one hand of a user;

FIG. 4 is a perspective view showing the device of the present invention electrically connected with a main unit of the large laser-carving machine; and

FIG. 5 is a perspective view showing the device of the present invention electrically connected with the main unit of the large laser cutter, with the user holding the device with one hand.

### DETAILED DESCRIPTION OF THE PREFERRED EMBODIMENT

The figures show a preferred embodiment of a device 1 in accordance with the present invention for controlling the emission of a laser beam in a large laser-carving machine 2.

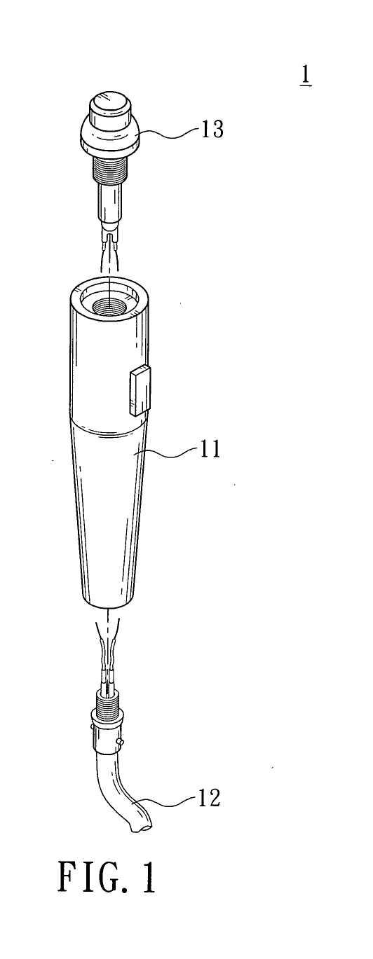

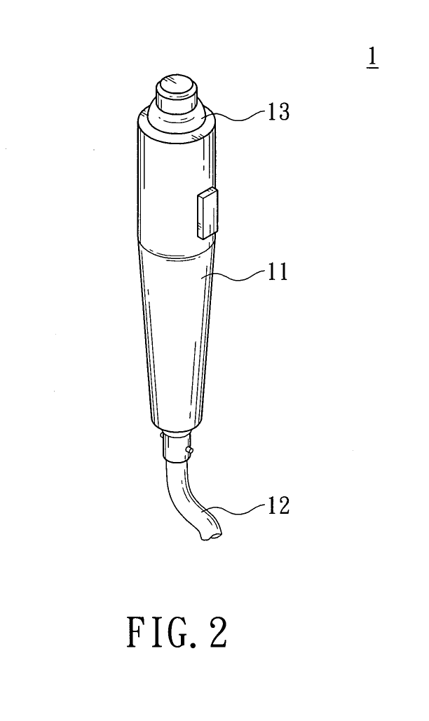

Referring to FIG. 1 and 2, the device 1 includes a portable controller 11 and a cable 12. The portable controller 11, preferably having a handy shape like a pen, is formed with a switch 13 and that is a button switch.

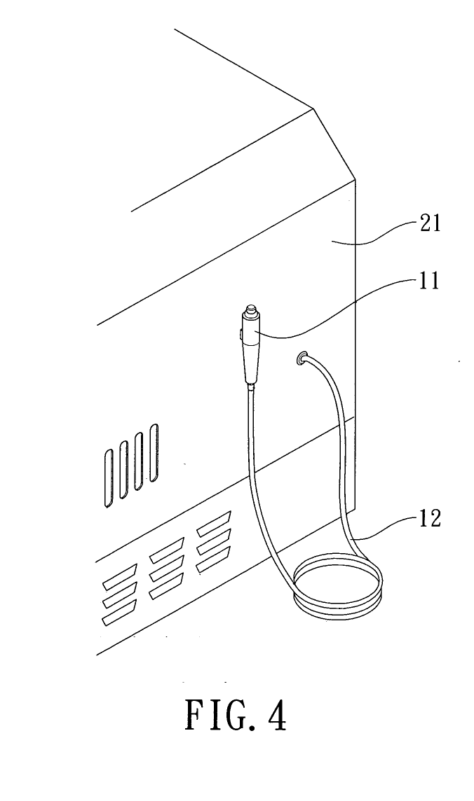

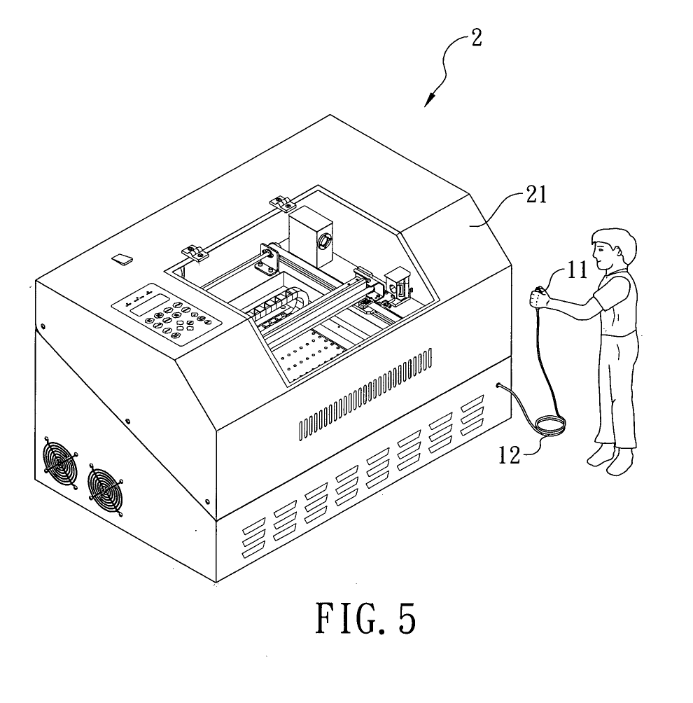

The cable 12 extends between the portable controller 11 and a main unit 21 of the large laser-carving machine 2, as shown in FIG. 4 and 5, and electrically connects the switch 13 of the portable controller 11 with the main unit 21 in such a way that the switch 13 may turn on/off a laser tube provided in the main unit 21. As an important feature of the present invention, the cable 12 should have a length long enough to allow a user holding the portable controller 11 to walk about the main unit 21 of the large laser-carving machine 2.

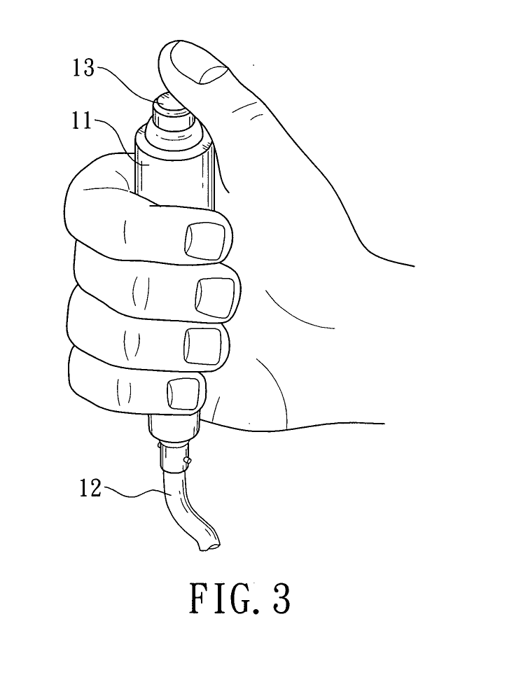

During adjusting the focus of the laser beam, as shown in FIG. 3 to 5, the user can hold the portable controller 11 with one hand. He/she may press the switch 13 immediately after adjusting the orientation of a reflector situated at one side of the main unit 21 for turning on the laser tube so as to examine whether the beam emitted from the laser tube is focused at a correct position. If it is not, the user may press the switch 13 again after adjusting the orientation of the reflector once more.

From the foregoing, it is apparent that the present invention is advantageous in that:
1. It allows the user to turn on the laser tube immediately after adjusting the orientation of the reflector without the need to walk to and from the control panel of the laser-carving machine. It can not only save time but also improve the accuracy of the adjustment; and
2. It also allows the user to turn on the laser tube at everywhere around the main unit of the machine.

Although the embodiment together with structures and functions of the present invention has been described in detail, many modifications and variations may be made from the teachings disclosed hereinabove. Therefore, it should be understood by those skilled in the art that any modification and variation equivalent to the spirit of the present invention should be regarded to fall into the scope defined by the appended claims.

What is claimed is:

1. A device for controlling the emission of a laser beam in a large laser-carving machine, comprising:
a portable controller formed with a switch; and
a cable extending between said portable controller and a main unit of said large laser-carving machine, said cable electrically connecting said switch with said main unit in such a way that said switch may turn on/off a laser tube provided in said main unit of said large laser-carving machine.

2. The device as claimed in claim 1, wherein said switch is a button switch.

3. The device as claimed in claim 1, wherein said portable controller has a handy shape like a pen.

4. The device as claimed in claim 1, wherein said cable has a length long enough to allow a user holding said portable controller to walk about said main unit of said large laser-carving machine.
